(19) United States
(12) Patent Application Publication
(10) Pub. No.: US 2025/0149927 A1
(43) Pub. Date: May 8, 2025

(54) POWER NEGOTIATION IN A WIRELESS POWER SYSTEM

(71) Applicant: GE Intellectual Property Licensing, LLC, Niskayuna, NY (US)

(72) Inventors: Jayanti Ganesh, Bangalore (IN); Viswanathan Kanakasabai, Bangalore (IN); Subbarao Tatikonda, Bangalore (IN)

(21) Appl. No.: 18/684,438

(22) PCT Filed: Sep. 27, 2022
(86) PCT No.: PCT/US2022/044937

§ 371 Date: Feb. 16, 2024

(30) Foreign Application Priority Data
Sep. 28, 2021 (IN) 202111043931

(51) Int. Cl. H02J 50/80; H02J 50/12

(52) U.S. Cl. CPC H02J 50/80; H02J 50/12

(57) ABSTRACT

This disclosure provides systems, methods and apparatuses for power negotiation in a wireless power system. The power negotiation occurs prior to a power transfer phase and enables a Power Transmitter and a Power Receiver to negotiate a Guaranteed Power that the Power Transmitter guarantees it can supply during the power transfer phase. The power negotiation technique can account for power transmission losses (PTx-loss) and power reception losses (PRx-loss). During the power negotiation (in a connected phase prior to the power transfer phase), the Power Receiver communicates a Requested Power negotiation value to the Power Transmitter. The Power Transmitter can determine the estimated PTx-loss and account for such losses when determining whether it has enough Available Power to satisfy the Requested Power negotiation value and the estimated PTx-loss. The Power Transmitter can reserve power out of an Available Power that is shared by other Power Transmitters using a same power source.

### RELATED APPLICATIONS

This application claims priority benefit of India Provisional Application No. 202111043931 filed Sep. 28, 2021.

### TECHNICAL FIELD

This disclosure relates generally to wireless power, and to power negotiation between a Power Transmitter and a Power Receiver.

### DESCRIPTION OF RELATED TECHNOLOGY

Some wireless power systems utilize wireless power technology to wirelessly provide power to cordless appliances that have a variable load, such as some types of blenders, kettles, air fryers, mixers, etc. In these wireless power systems, a Power Transmitter (sometimes also referred to as a “wireless power transmission apparatus”) may be installed on or included in a countertop, a flat surface, a cooktop, or integrated in a stand-alone wireless power source for table-top usage. A Power Receiver (sometimes also referred to as a “wireless power reception apparatus”) may be included in a cordless appliance. The Power Transmitter may include a primary coil that uses magnetic induction to charge the Power Receiver. For example, the primary coil may produce an electromagnetic field. The Power Receiver may capture the electromagnetic field using a secondary coil and may convert it to electric power or use it for direct induction heating. Thus, the wireless power system can provide wireless power or induction heating to operate a cordless appliance.

### SUMMARY

The systems, methods, and apparatuses of this disclosure each have several innovative aspects, no single one of which is solely responsible for the desirable attributes disclosed herein.

One innovative aspect of the subject matter described in this disclosure can be implemented as a method for power negotiation by a Power Transmitter. The method includes receiving a Requested Power negotiation value from a Power Receiver prior to a power transfer phase. The method includes determining estimated power transmission losses (PTx-loss) of the Power Transmitter associated with transmitting wireless power to the Power Receiver. The method includes negotiating a Guaranteed Power for the Power Receiver based, at least in part, on the Requested Power negotiation value, the estimated PTx-loss, and Available Power of the Power Transmitter. The method includes reserving, from the Available Power, a Negotiated Power (P-nego) for transmission of the wireless power to the Power Receiver during the power transfer phase, wherein the Negotiated Power is a sum of the Guaranteed Power and the estimated PTx-loss.

Another innovative aspect of the subject matter described in this disclosure can be implemented as a method for power negotiation by a Power Receiver. The method includes communicating a Requested Power negotiation value to a Power Transmitter prior to a power transfer phase, the Requested Power negotiation value based, at least in part, on a power rating of a load associated with the Power Receiver. The method includes negotiating a Guaranteed Power with the Power Transmitter based on the Requested Power negotiation value, wherein the Guaranteed Power represents a power level that the Power Transmitter guarantees to have available for transmission to the Power Receiver during the power transfer phase based on Available Power of the Power Transmitter and estimated power transmission losses (PTx-loss) of the Power Transmitter.

Another innovative aspect of the subject matter described in this disclosure can be implemented as a Power Transmitter of a wireless power system. The Power Transmitter includes a primary coil configured to transmit wireless power to a secondary coil of a Power Receiver during a power transfer phase. The Power Transmitter includes a communication unit configured to receive a Requested Power negotiation value from a Power Receiver prior to the power transfer phase. The Power Transmitter includes a power controller configured to determine estimated power transmission losses (PTx-loss) of the Power Transmitter associated with transmitting the wireless power to the Power Receiver, negotiate a Guaranteed Power for the Power Receiver based, at least in part, on the Requested Power negotiation value, the estimated PTx-loss, and Available Power of the Power Transmitter, and reserve, from the Available Power, a Negotiated Power (P-nego) for transmission of the wireless power to the Power Receiver during the power transfer phase, wherein the Negotiated Power is a sum of the Guaranteed Power and the estimated PTx-loss.

Another innovative aspect of the subject matter described in this disclosure can be implemented as a Power Receiver of a wireless power system. The Power Receiver includes a communication unit configured to communicate a Requested Power negotiation value to a Power Transmitter prior to a power transfer phase, the Requested Power negotiation value based, at least in part, on a power rating of a load associated with the Power Receiver. The Power Receiver includes a controller configured to negotiate a Guaranteed Power with the Power Transmitter based on the Requested Power negotiation value, wherein the Guaranteed Power represents a power level that the Power Transmitter guarantees to have available for transmission to the Power Receiver during the power transfer phase based on Available Power of the Power Transmitter and estimated power transmission losses (PTx-loss) of the Power Transmitter.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows a block diagram of an example wireless power system that includes an example Power Transmitter and an example Power Receiver.

FIG. 2 illustrates a perspective view of an example countertop-mounted Power Transmitter.

FIG. 3 illustrates a perspective view of an example countertop-mounted Power Transmitter and an example cordless appliance that includes a Power Receiver.

FIG. 4 shows an example system state diagram with example power negotiation operations.

FIG. 5 shows a block diagram conceptually illustrating an example power negotiation and control.

FIG. 6 shows a block diagram conceptually illustrating an example power negotiation and control that takes into account power transmission losses (PTx-loss) estimated by a Power Transmitter.

FIG. 7 shows a message flow diagram conceptually illustrating an example power negotiation.

FIG. 8 shows a flow diagram illustrating example operations of a process performed by a Power Transmitter.

FIG. 9 shows a flow diagram illustrating example operations of a process performed by a Power Receiver.

FIG. 10 shows a block diagram of an example apparatus for use in wireless power system.

Note that the relative dimensions of the figures may not be drawn to scale.

### DETAILED DESCRIPTION

The following description is directed to certain implementations for the purposes of describing innovative aspects of this disclosure. However, a person having ordinary skill in the art will readily recognize that the teachings herein can be applied in a multitude of different ways. The described implementations can be implemented in any means, apparatus, system, or method for transmitting or receiving wireless power.

A wireless power system may include a Power Transmitter integrated with or otherwise disposed on a surface. The Power Transmitter may include a primary coil that transmits wireless energy (as a wireless power signal) to a corresponding secondary coil in a Power Receiver. For example, the Power Transmitter may include a countertop-mounted primary coil or a primary coil that is embedded or manufactured in a surface on which a Power Receiver can be placed. A primary coil refers to a source of wireless energy (such as inductive or magnetic resonant energy) in the Power Transmitter. A secondary coil located in the Power Receiver may receive the wireless energy and utilize it to charge or power a load or for induction heating. In some implementations, a Power Receiver may be included or integrated with a cordless appliance having a variable load (such as a blender, heating element, a fan, among other examples). In some implementations, the Power Receiver may be included or integrated with a cordless appliance having a fixed load).

A magnetic power source may refer to an appliance (such as a cooktop or hob) that includes multiple Power Transmitters to provide wireless power to respective Power Receivers. The Power Transmitters in such a magnetic power source typically share a limited power supply—such as a single wall outlet—and therefore typically cannot be operated simultaneously at full power. Exceeding the rated power of the magnetic power source can lead to tripping circuit breakers somewhere in the building, which is a highly undesirable situation. Such devices may use power negotiation to establish an agreed amount of power that a Power Transmitter will reserve for a particular Power Receiver.

This disclosure provides systems, methods and apparatuses for power negotiation between a Power Transmitter and a Power Receiver. Power negotiation may ensure that an appliance containing the Power Receiver can function as intended by reserving the amount of power to do so. Before a power transfer phase, the Power Receiver can communicate a Requested Power negotiation value to the Power Transmitter. The Requested Power negotiation value represents a maximum power level that the Power receiver may require to operate its load. The Requested Power negotiation value is communicated prior to a power transfer phase; thus, the Requested Power negotiation value may be referred to as a requested power level, a power negotiation value (PRx-nego), or a pre-power Requested Power to distinguish it from a traditional Power Request (P-request) message (sometimes also referred to as a Requested Power message) that may be communicated during the power transfer phase to control power. The Power Transmitter can determine whether to accept or reject the Requested Power negotiation value based on the Available Power of the Power Transmitter. Available Power refers to the highest amount of power that a Power Transmitter has available for wireless power transfer given instantaneous ambient conditions. Ambient conditions include, among others, the Power Transmitter's input power and voltage, its temperature, magnetic coupling of the Power Receiver. In a magnetic power source having multiple Power Transmitters, ambient conditions also may include the power usage of any other Power Transmitters or functions of the magnetic power source. For example, the multiple Power Transmitters can use the power negotiation techniques of this disclosure to reserve power from the Available Power provided by the magnetic power source.

The Power Transmitter can determine whether it can guarantee the requested power level (represented by the Requested Power negotiation value) based on the Available Power and estimated losses of the Power Transmitter. For example, the Power Transmitter may estimate the losses associated with its own components (such as its rectifier, inverter, coil, or filter components, among other examples) for servicing the requested power level. If the Available Power is more than the Requested Power negotiation value and the estimated losses, the Power Transmitter may accept the Requested Power negotiation value; otherwise, the Power Transmitter may reject the Requested Power negotiation value or may communicate an alternative power negotiation value for a power level that is lower than the requested power level. When the Power Transmitter accepts the Requested Power negotiation value, the Power Transmitter may set the Requested Power negotiation value as a Guaranteed Power to represent a power level that the Power Transmitter will guarantee to be available for transmission to the Power Receiver. The Power Transmitter may reserve a Negotiated Power (P-nego) out of the Available Power to ensure that the Power Transmitter has enough power to satisfy the Guaranteed Power. The Negotiated Power may be the sum of the Guaranteed Power and the estimated losses.

In some implementations, a Power Receiver may communicate a Requested Power negotiation value that takes into account a power rating of a load associated with the Power Receiver. The Requested Power negotiation value also may take into account power reception losses (PRx-loss) associated with components of the Power Receiver. However, the Requested Power negotiation value may exclude power transmission losses (PTx-loss) associated with components of the Power Transmitter since those losses will be estimated by the Power Transmitter.

In some implementations, the Power Transmitter may determine an operating coupling factor (K-factor) between the Power Transmitter and the Power Receiver. An operating K-factor refers to a K-factor based on an actual alignment between the Power Receiver and the Power Transmitter. The Power Transmitter may adjust the PTx-loss based on the K-factor.

Particular implementations of the subject matter described in this disclosure can be implemented to realize one or more of the following potential advantages. Power negotiation can be done efficiently and effectively between a Power Receiver and a Power Transmitter. Furthermore, a Power Transmitter can reserve an appropriate amount of power to satisfy guaranteed power to a Power Receiver. In a system having multiple Power Transmitters sharing a total Available Power, the reservation of Negotiated Power (which includes estimated power transmission losses) ensures that the system does not get overloaded above its total power rating. Furthermore, in some implementations, the Power Receiver does not need to estimate or determine PTx-loss when negotiating a guaranteed power. Rather, the Power Transmitter, being better suited to determine the PTx-loss, can account for such power transmission losses when determining whether it can satisfy a requested power level.

While the examples in this disclosure are based on wireless power used in kitchen systems, the techniques are applicable to other types of systems. For example, the techniques may be used with wireless power systems associated with home appliances, electronic devices, fans, space heaters, speaker systems, air compressors, garden equipment, or components of an electric vehicle, among other examples.

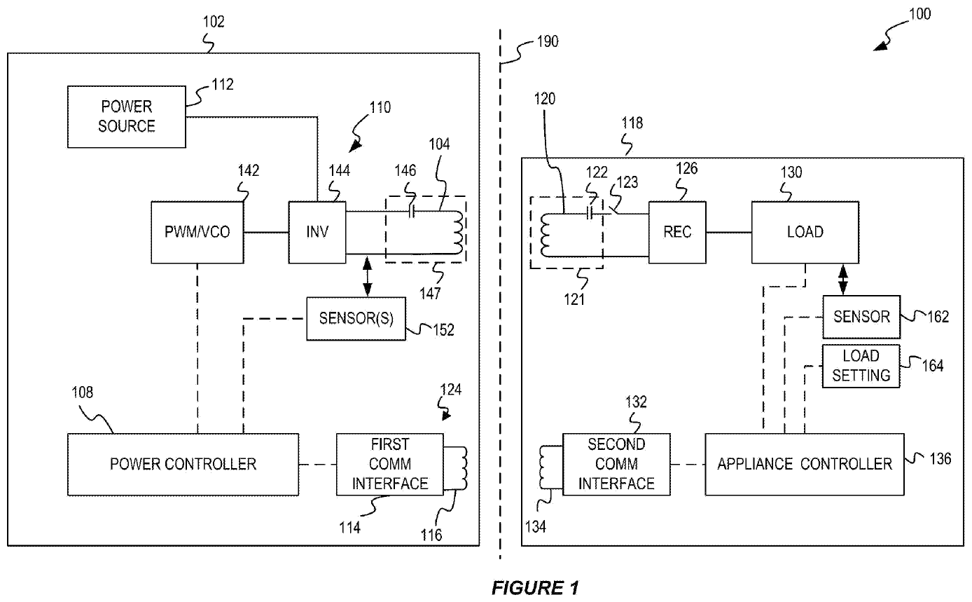

FIG. 1 shows a block diagram of an example wireless power system 100 that includes an example Power Transmitter 102 and an example Power Receiver 118. A Power Transmitter (sometimes referred to as “PTx”) is a functional unit that converts electric power to magnetic power. In this disclosure, the Power Transmitter 102 includes the PTx as well a communication system and other electrical components. A Power Receiver (sometimes also referred to as “PRx”) is a part of a wireless power transfer system that converts magnetic power to electric power or heat. In this disclosure, the Power Receiver 118 includes the PRx as well as a communication system and other electrical components. The Power Transmitter 102 and the Power Receiver 118 may be separated by an interface space 190. In FIG. 1, dashed lines represent communications to distinguish from solid lines that represent electrical circuit lines. The Power Transmitter 102 includes a primary coil 104. The primary coil 104 may be a wire coil which transmits wireless power (which also may be referred to as wireless energy). The primary coil 104 may transmit wireless energy using inductive or magnetic resonant field. The primary coil 104 may be associated with a power transmitter circuit 110. The power transmitter circuit 110 may include components such as a pulse width modulator or voltage controlled oscillator 142, an inverter 144, and a series capacitor 146. The capacitor 146 and the primary coil 104 are sometimes also referred to as an “tank circuit 147”. The power transmitter circuit 110 may also include other components (not shown) for impedance matching. The Power Transmitter 102 also may include one or more sensors 152, such as a voltage sensor and a current sensor (not shown).

Some or all of the power transmitter circuit 110 may be embodied as an integrated circuit (IC) that implements features of this disclosure for controlling and transmitting wireless power to one or more Power Receivers. The power controller 108 may be implemented as a microcontroller, dedicated processor, integrated circuit, application specific integrated circuit (ASIC) or any other suitable electronic device.

The power source 112 may provide power to the power transmitter circuit 110 in the Power Transmitter 102. The power source 112 may convert alternating current (AC) power to direct current (DC) power. For example, the power source 112 may include a converter that receives an AC power from an external power supply and converts the AC power to a DC power used by the power transmitter circuit 110.

The power controller 108 is connected to a first communication interface 114. The first communication interface 114 is connected to a first communication coil 116. In some implementations, the first communication interface 114 and the first communication coil 116 may be collectively referred to as the first communication unit 124. In some implementations, the first communication unit 124 may support Near-Field Communication (NFC). NFC is a technology by which data transfer occurs on a carrier frequency of 13.56 Megahertz (MHz). The first communication unit 124 also may support any suitable communication protocol.

The Power Receiver 118 may include a secondary coil 120, a series capacitor 122, a series switch 123, a rectifier 126, an appliance controller 136, a second communication interface 132, a sensor 162, a load 130, and a memory (not shown). The capacitor 122 and the secondary coil 120 are sometimes also referred to as an “tank circuit 121”. In some implementations, the Power Receiver 118 also may include a user interface (not shown) or other means for obtaining a load setting 164 indicating a desired operation of the load. In some implementations, the load setting 164 may be stored in a memory (not shown) of the Power Receiver 118. In some implementations, the load 130 may also include a drive (not shown) for controlling at least one parameter such as speed or torque of the load. In some implementations, the rectifier 126 may be omitted. In some implementations, a series switch (not shown) may be included in series with the secondary coil 120. Although shown as different components, some components may be packaged or implemented in the same hardware. For example, in some implementations, the appliance controller 136 and a power reception controller (not shown) may be implemented as a single controller. The appliance controller 136, or any combination thereof, may be implemented as a microcontroller, dedicated processor, integrated circuit, application specific integrated circuit (ASIC) or any other suitable electronic device.

An interface space 190 may demark a space between the Power Transmitter 102 and the Power Receiver 118. For example, the interface space may include a surface of the Power Transmitter 102 on which the Power Receiver 118 may be placed. A distance between the primary coil 104 and the secondary coil 120 may include a thickness of a surface in the interface space 190. During wireless power transfer, the primary coil 104 may induce a magnetic field (referred to as the primary magnetic field) through the interface space 190 and into an operative environment in which the secondary coil 120 is placed. Thus, the “operative environment” is defined by the primary magnetic field in the system, where the primary magnetic field of a primary coil 104 is detectably present and can detectably interact with the secondary coil 120.

The power controller 108 may detect the presence or proximity of a Power Receiver 118. This detection may happen during a periodic pinging process of the first communication interface 114 in the Power Transmitter 102. During the pinging process, the first communication interface 114 also may supply power (via the first communication coil 116) to the second communication interface 132 (via the second communication coil 134) when the Power Receiver 118 is in proximity. The second communication interface 132 may “wake up” and power-up the appliance controller 136 and may send a reply signal back to the first communication interface 114. Prior to power transfer, a handshaking process may take place during which the power controller 108 may receive data configuration related to the power rating of the receiver, among other information.

Different cordless appliances have different load types, different load states, and different power requirements or may require power at a particular voltage and frequency. For example, a cordless blender may include a variable motor load that has multiple user-selectable load states to control motor speed. Depending on the load state, the cordless blender may require different levels of power to operate. In another example, a cordless kettle may include a resistive load that has different load states to control temperature. In yet another example, an air fryer may be a compound load device and may operate a heater, a fan, or both, at various periods of operation. Each type of load (such as the motor, the resistive load, the heater, the fan, or any combination thereof) may require different amounts of power to operate based on a current load state or load state. Furthermore, cordless appliances may exhibit different levels of voltage gains from a primary coil to a receiver coil at different primary coil excitation frequencies (such as a wireless power transfer frequency) depending on their load type or load state. For example, to achieve a desired load voltage, a cordless blender may operate best at a first operating frequency for a first load state, such as a low motor speed setting. However, as the load state changes, the cordless blender may not achieve the same load voltage when operated at the first operating frequency. For example, the first operating frequency may facilitate a first voltage gain when the cordless blender is set to a first load state (such as a low-speed setting), but the first operating frequency may provide a lower voltage gain when the cordless blender is set to a second setting (such as a higher-speed setting). The load setting 164 may indicate a current load state or a required power needed for the load to operate in the load state.

The power controller 108 may control characteristics of wireless power that that the Power Transmitter 102 provides to the Power Receiver 118. After detecting the Power Receiver 118, the power controller 108 may receive configuration data from a Power Receiver 118. For example, the power controller 108 may receive the configuration data during a hand shaking process with the Power Receiver 118. The power controller 108 may use the configuration data to determine at least one operating parameter (such as frequency, duty cycle, voltage, etc.) for wireless power generated by the power transmitter circuit 110. The operating parameter may be adjusted based on feedback information from the Power Receiver 118 during the transfer of wireless power in response to a change in the load state or power requirement of the load 130. Thus, the power controller 108 may provide wireless power that enables relatively efficient operation of the Power Receiver 118. For example, the transmission controller may configure the wireless power to enable the Power Receiver to operate at peak efficiency for a particular load state, load voltage and operating K-factor.

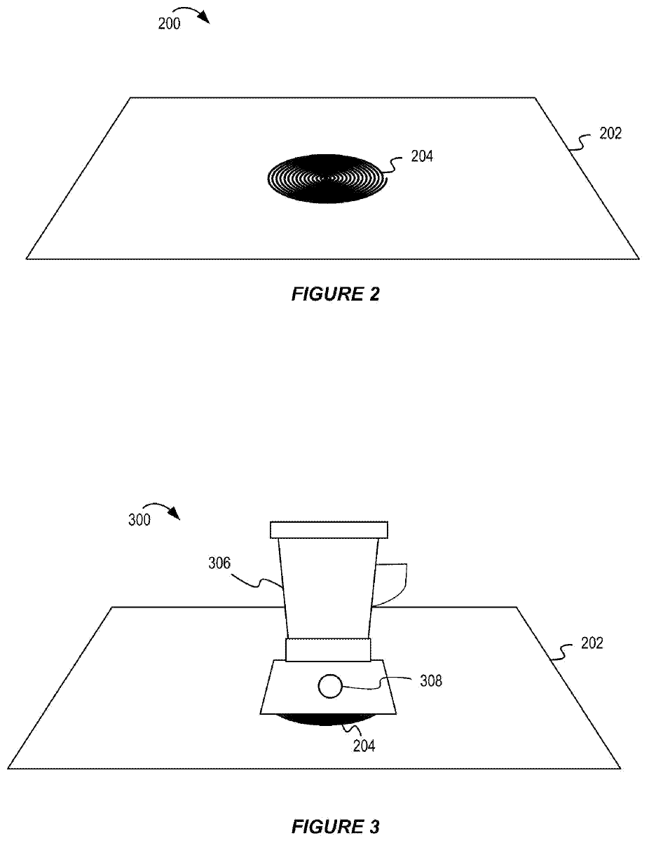

FIG. 2 illustrates a perspective view 200 of an example countertop-mounted Power Transmitter. In some implementations, the Power Transmitter may be coupled with or integrated with a countertop 202. For example, a primary coil 204 of the Power Transmitter may be flush-mounted into the countertop 202. For brevity, only the primary coil 204 of the Power Transmitter is illustrated in FIG. 2. However, other components of the Power Transmitter, such as those describe with reference to FIG. 1, may be integrated or mounted into the countertop 202.

FIG. 3 illustrates a perspective view 300 of an example countertop-mounted Power Transmitter and an example cordless appliance that includes a Power Receiver. The cordless appliance (shown as a blender 306) may be placed on the primary coil 204. The cordless appliance may include a user-selectable load setting 308. The cordless appliance may include a Power Receiver (not shown in FIG. 3). The Power Transmitter and the Power Receiver may include any of the components and functionalities described herein.

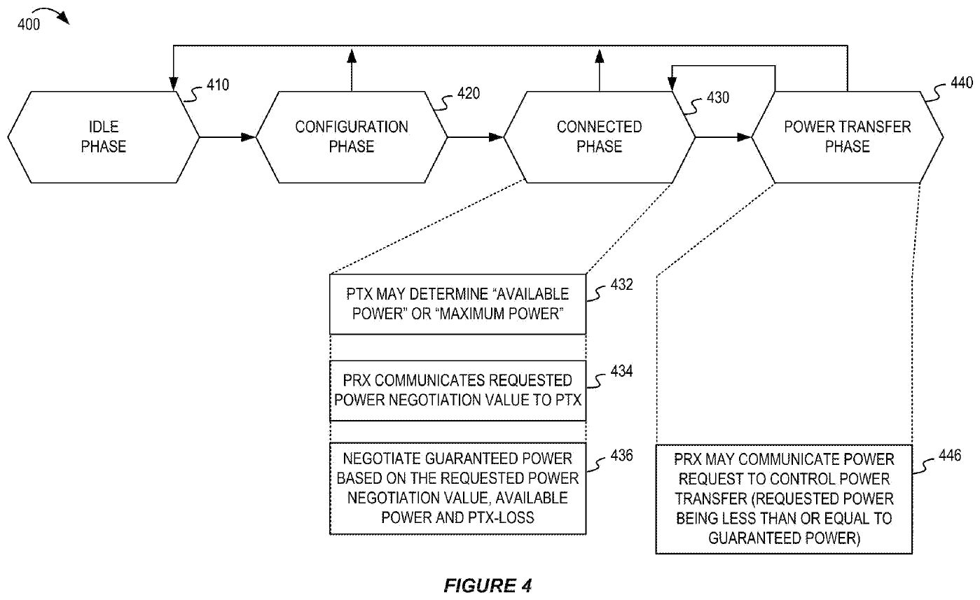

FIG. 4 shows an example system state diagram 400 with example power negotiation operations. The system state diagram 400 consists of four main phases. The Power Transmitter enters the idle phase 410 when the user connects it to the mains. In the idle phase 410, the Power Transmitter looks for the presence of a valid receiver and when detected, establishes communication. In the idle phase 410, the Power Transmitter is in standby until it detects an event that initiates object classification. If the object is a Power Receiver with a communication unit, the Power Transmitter initiates communication then moves to the configuration phase 420. After the activation of the Power Receiver, the Power Transmitter moves into the configuration phase 420 and receives the static configuration data. The system state diagram 400 also shows the connected phase 430 which follows the configuration phase 420 and before a power transfer phase 440. Power transfer from the Power Transmitter to the Power Receiver occurs during the power transfer phase 440.

In the configuration phase 420 or the connected phase 430, the Power Transmitter and Power Receiver exchange information to agree and adjust parameters related to wireless power transfer or wireless charging. Power negotiation may occur during any of the phases before the power transfer phase 440. For brevity, the power negotiation operations are described as occurring in the connected phase 430. Power negotiation is used by the Power Transmitter and Power Receiver to negotiate the parameters that govern the power transfer phase 440. For example, shown at block 432, the Power Transmitter may determine and the Available Power or the Maximum Power. Shown at block 434, the Power Receiver may communicate a Requested Power negotiation value to the Power Transmitter. The Requested Power negotiation value may be based on the power rating of the load. In some implementations, the Requested Power negotiation value is based on a combination of the power rating of the load and power reception losses (PRx-loss). The Requested Power negotiation value may omit or disregard the power transmission losses (PTx-loss) since those will be estimated and accounted for by the Power Transmitter during power negotiation. Shown at block 436, the Power Receiver and the Power Transmitter may negotiate a Guaranteed Power based on the Requested Power negotiation value, the estimated PTx-loss, and the Available Power. For example, the Power Transmitter may accept or reject the Requested Power negotiation value as the Guaranteed Power. For example, the Power Transmitter may accept the Requested Power negotiation value as the Guaranteed Power if the Available Power is more than a sum of the Requested Power negotiation value and the estimated PTx-loss.

The power negotiation described with reference to FIG. 4 is an example in which the Requested Power negotiation value is accepted by the Power Transmitter. However, there may be cases when the Power Transmitter cannot accept the Requested Power negotiation value as the Guaranteed Power. For example, the Power Transmitter may determine that the Available Power is less than the sum of the Requested Power negotiation value and the estimated PTx-loss. The Power Transmitter may communicate a message to the Power Receiver indicating that the Power Transmitter rejects the Requested Power negotiation value. In some implementations, the Power Receiver may communicate a subsequent Requested Power negotiation value and wait for an acceptance or rejection of the Requested Power negotiation value as the Guaranteed Power. In some implementations, the Power Transmitter may calculate an alternative power negotiation value that the Power Transmitter can satisfy based on the Available Power minus the estimated PTx-loss. The Power Transmitter may communicate the alternative power negotiation value (sometimes referred to as a suggested power negotiation value) to the Power Receiver. The Power Receiver may respond with an acknowledgement if the Power Receiver accepts the alternative power negotiation value as the Guaranteed value.

Once the Guaranteed Power has been negotiated, the Power Transmitter may calculate a Negotiated Power (P-nego) based on a sum of the Guaranteed Power and the estimated PTx-loss. The Power Transmitter may reserve the Negotiated Power out of the Available Power, thereby reducing the Available Power for other Power Transmitters that share the Available Power. Each Power Transmitter may perform similar power negotiation (and reservations of Negotiated Power) with their respective Power Receivers using the Available Power remaining after reservations from other Power Transmitters. Because the Negotiated Power accounts for the estimated PTx-loss, the total power usage by multiple Power Transmitters will not exceed the Maximum Power of the power source.

From the connected phase 430, the Power Receiver can request the Power Transmitter to move to the power transfer phase 440 or back to the idle phase 410. In the power transfer phase 440, the Power Transmitter may perform Foreign Object Detection (FOD) operations, then applies the power signal to transmit wireless power to the Power Receiver, repeating this cycle for the duration of the power transfer phase 440. Communication or FOD is performed during each slot in the power signal. Some examples of the communication in the power transfer phase 440 may be relevant to power negotiation. For example, during the power transfer phase 446, the Power Receiver may communicate a Power Request (P-request) message (sometimes referred to as “Requested Power”) to cause the Power Transmitter to adjust the power level of the wireless power transfer to the Power Receiver. The Requested Power during power transfer phase may not exceed the Guaranteed Power negotiated between the Power Transmitter and the Power Receiver.

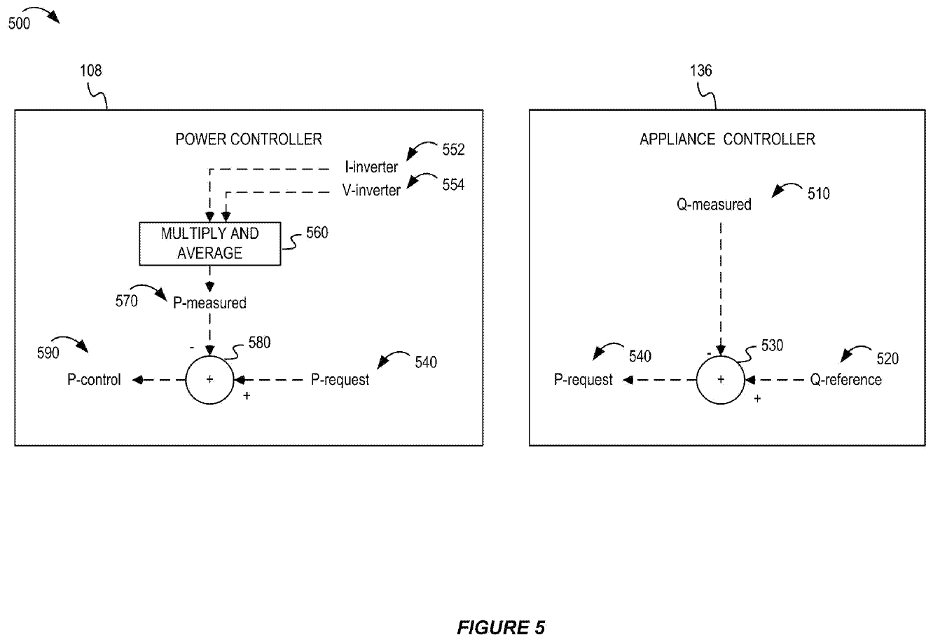

FIG. 5 shows a block diagram conceptually illustrating an example power negotiation and control. The operations of the Power Transmitter and Power Receiver are illustrated in terms of the power controller 108 and the appliance controller 136, respectively. Prior to the power transfer phase, the appliance controller 136 may communicate a Requested Power negotiation value to negotiate a Guaranteed Power. Once the Guaranteed Power has been negotiated and accepted by the Power Transmitter and the Power Receiver, the Power Transmitter may reserve, from an Available Power, a Negotiated Power that includes the Guaranteed Power and estimated power transmission losses (PTx-loss).

During the power transfer phase, the Power Receiver or a component thereof (such as an appliance controller 136) may communicate a Power Request (P-request) message 540 based on an error calculation 530 between a reference quantity (Q-reference 520) and an actual measured quantity (Q-measured 510). The quantity Q may refer to voltage, speed, torque, temperature, or other parameter associated with operating the load. For example, the Q-measured 510 may be obtained by the sensor 162 described with reference to FIG. 1. The Q-reference 520 may be obtained based on the load setting 164 described with reference to FIG. 1. The Power Request (P-request) message 540 must indicate a requested power that is equal to or less than the Guaranteed Power negotiated prior to the power transfer phase.

The Power Transmitter or a component thereof (such as a power controller 108) may adjust a power control setting (P-control 590) based on the P-request 540 and a measured power transmission (P-measured 570). P-measured 570 may be determined (shown at block 560) by an average of multiplying inverter current (I-inverter 552) and inverter voltage (V-inverter 554). The I-inverter 552 and the V-inverter 554 may be obtained using sensors, such as sensors 152 described with reference to FIG. 1. An error calculation 580 can determine the difference between the P-measured 570 and the P-request 540 to produce the P-control 590 value.

The operations described with reference to FIG. 5 illustrate a problem that exists in some legacy power negotiation techniques. The P-request 540 value is not well defined in wireless power systems, which has led to some confusion about how it should be calculated. Some legacy systems calculate the P-request 540 to include an estimate of PTx-loss, PRx-loss, and either a load power requirement or a power rating of the load. However, the appliance controller 136 may not know the PTx-loss or have an effective means to measure or detect the PTx-loss. Consequently, the P-request 540 may include an over-inflated value causing the Power Transmitter to reserve more power than is necessary to power the load. Furthermore, some Power Receivers may use different offsets or calculations for PTx-loss, making the reliability of a power negotiation impractical for a Power Transmitter that supports different types of Power Receivers. In accordance with this disclosure, the power negotiation may occur prior to the power transfer phase. Furthermore, the Power Receiver and the Power Transmitter each account for their respective estimated losses when communicating a Power Request negotiation value and Guaranteed Power, respectively.

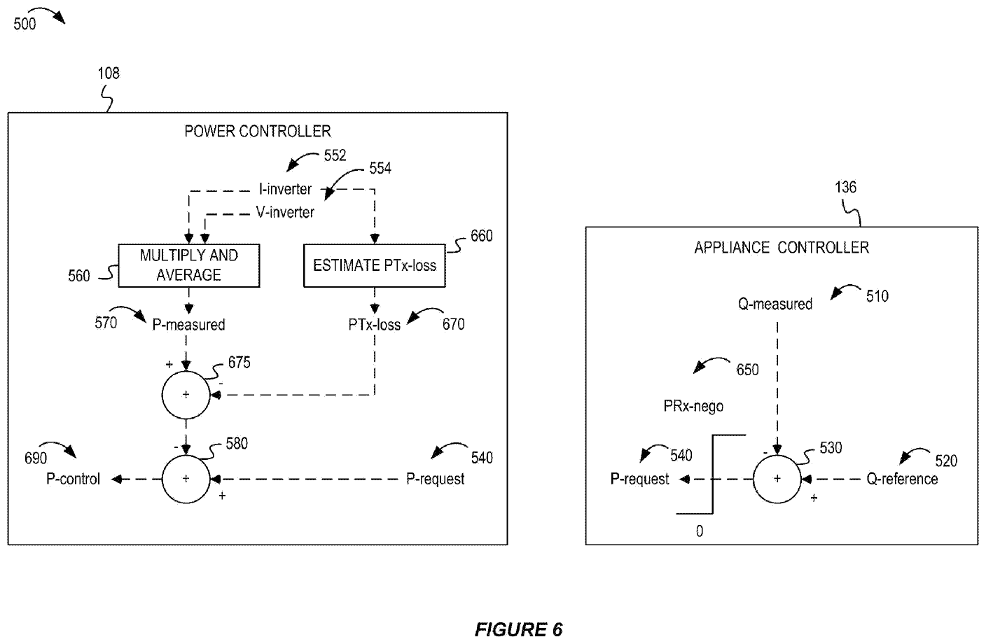

FIG. 6 shows a block diagram conceptually illustrating an example power negotiation and control that takes into account power transmission losses (PTx-loss) estimated by a Power Transmitter. The features in FIG. 6 are equivalent to those with corresponding reference numerals in FIG. 5. However, one difference is that the Power Request negotiation value (during the connected phase) is defined to exclude the PTx-loss since the PTx-loss will be estimated or calculated by the Power Transmitter.

In the connected phase, the Power Receiver (appliance controller 136) communicates a Requested Power negotiation value 650. In some implementations, the Requested Power negotiation value 650 may take the same form as a traditional power request message except that it is communicated during the connected phase and is used for power negotiation of a Guaranteed Power. The Requested Power negotiation value 650 may be based on a power rating of the load and estimated power receiver losses (PRx-loss) but may not include estimated PTx-loss. In some implementations, the PRx-loss may be measured during manufacturing and stored or otherwise programmed into the appliance controller 136. Misalignment and K-factor may only insignificantly impact PRx-loss (as compared to PTx-loss).

The Power Transmitter (power controller 108) may estimate PTx-loss. During the connected phase (prior to power transfer), the PTx-loss may be an estimate based on a value stored in memory, a calculation based on an estimated power or otherwise programmed. In the connected phase, the Power Transmitter may estimate the PTx-loss since an actual PTx-loss may not be measured until the power transfer phase. To estimate the PTx-loss, the power controller 108 may estimate a copper loss (PTx-copper-loss) associated with a primary coil of the Power Transmitter. For example, the copper loss may be calculated using a product of a resistance (R) associated with the primary coil and a square of an estimated rated current (Iᵢₙᵥ²) associated with an inverter of the Power Transmitter to meet the Requested Power negotiation value 650. The power controller 108 also may estimate other losses and include the other losses in the estimated PTx-loss. For example, other losses may include power transmission losses associated with electronics, a capacitor, friendly metals, ferrites, or any combination thereof, associated with the Power Transmitter to meet the Requested Power negotiation value. In some implementations, the PTx-loss may be estimated based on a K-factor estimate or other estimation of the coupling factor between the Power Transmitter and the Power Receiver.

The Power Transmitter 108 may set a Guaranteed Power based on the Requested Power negotiation value if the Available power is greater than a sum of the Requested Power negotiation value and the estimated PTx-loss. Once the Guaranteed Power has been negotiated, the Power Transmitter may calculate a Negotiated Power (P-nego) may be based on the Guaranteed Power plus the estimated PTx-loss. The Negotiated Power is the power level that must be reserved out of the Available Power to ensure that the Power Transmitter can satisfy the Guaranteed Power to the Power Receiver. The Power Transmitter may reserve the Negotiated Power from the Available Power, thereby reducing the Available Power that remains available for other Power Transmitters or components using a shared power source.

During power transfer phase, the Power Receiver (appliance controller 136) may control the Requested Power by sending a P-request message 540. The P-request 540 may be limited to a maximum value equal to the Guaranteed Power. The Power Transmitter may measure PTx-loss 670 and measured power transmission (P-measured 570). The P-measured 570 may be determined as described with reference to FIG. 5. In some implementations, the P-measured 570 can be determined based on an average of the product of the direct current (DC) input voltage to the inverter and the DC current input of the inverter. The PTx-loss 670 may be calculated (shown at block 660) based on one or more of the addition of PTx-copper-loss, losses in the PTx ferrites, friendly metals, and the losses in the electronics and other components in the tank circuit. For example, the PTx-copper-loss may be calculated (formula 1) as a product of a resistance (R) associated with a primary coil of the Power Transmitter and a square of a measured current (Iᵢₙᵥ²) associated with the primary coil.

$$PTx - copper - loss = {I}_{inv}^{2} R \qquad ( 1 )$$

The example calculation for PTx-copper-loss is just one example and other formulas or calculations may be envisioned within the scope of this disclosure.

The Power Transmitter (power controller 108) may add the P-measured 570 and the PTx-loss 670 (as a negative value) to determine an estimated transmitted power. An error calculation 580 can determine the difference between the estimated transmitted power and the P-request 540 to produce the P-control 690 value.

In some implementations, the Guaranteed Power is negotiated based on worst case scenario so that the Power Transmitter can ensure that it can deliver the Guaranteed Power to the Power Receiver if the Power Receiver requests the full amount. If the Power Receiver or the Power Transmitter have a change in conditions, they may perform a new power negotiation to set a new Guaranteed Power level based on the changed conditions.

In some implementations, the Power Transmitter may re-adjust the Negotiated Power reserved from the Available Power based on operating conditions to meet a max demand of Guaranteed Power. For example, if the measured PTx-loss (during power transfer phase) is different from the estimated PTx-loss (during connected phase), the Power Transmitter can adjust the Negotiated Power (P-nego) to accommodate the change in PTx-loss and reserve the adjusted Negotiated Power from the Available Power, assuming that the Available Power is higher than the adjusted Negotiated Power. In some implementations, the Power Transmitter may initiate a new power negotiation (either during power transfer phase or connected phase) if the Guaranteed Power cannot be met due to a change in the Available Power or operating conditions.

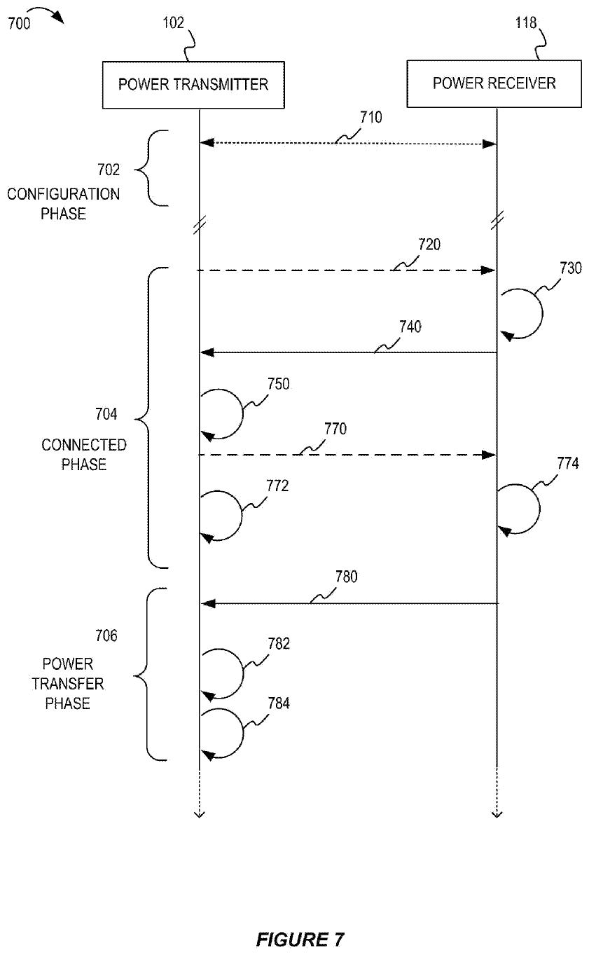

FIG. 7 shows a message flow diagram 700 conceptually illustrating an example power negotiation. A Power Transmitter 102 and a Power Receiver 118 may establish communication during a configuration phase 702 and exchange identification and configuration messages 710. In the connected phase 704, the Power Transmitter 102 and the Power Receiver 118 may perform a power negotiation. In some implementations, the Power Transmitter 102 may determine and communicate a negotiation message 720 that indicates an Available Power or a Maximum Power. At 730, the Power Receiver 118 may determine a Requested Power negotiation value. The Requested Power negotiation value may be based on a power rating of the Power Receiver 118 and power reception losses (PRx-loss). The PRx-loss may be estimated, calculated, measured or programmatically configured. The Power Receiver 118 may communicate a negotiation message 740 that includes the Requested Power negotiation value. At 750, the Power Transmitter 102 may estimate power transmission losses (PTx-loss). The PTx-loss may be estimated, calculated, measured or programmatically configured. In some implementations, the estimated PTx-loss may be the losses that are expected to reduce the actual transmitted power to the Power Receiver 118 based on current conditions and the requested power level associated with the Requested Power negotiation value.

If the Power Transmitter 102 can reserve the amount of power that corresponds to the Requested Power negotiation value plus the PTx-loss, the Power Transmitter 102 may communicate a response message 770 indicating that the Power Transmitter 102 accepts the Requested Power negotiation value as the Guaranteed Power. Otherwise, if the Power Transmitter 102 cannot reserve the amount of power that corresponds to the Requested Power negotiation value plus the PTx-loss, the Power Transmitter 102 may communicate a response message 770 indicating that the Power Transmitter 102 rejects the Requested Power negotiation value. In some implementations, the Power Transmitter 102 may communicate a negotiation message in addition to, or lieu of, the response message 770 to indicate an alternative power negotiation value. In some implementations, the alternative power negotiation value by the transmitter may correspond to the Available Power minus the estimated PTx-loss.

Continuing with FIG. 7, in the illustrated example, the Power Transmitter 102 has accepted the Requested Power negotiation value. At 772, the Power Transmitter 102 sets the Guaranteed Power based on the Requested Power negotiation value. The Power Transmitter 102 also calculated a Negotiated Power as a sum of the Guaranteed Power and the estimated PTx-loss. Then the Power Transmitter 102 reserves the Negotiated Power out of the Available Power. The Available Power for the power source may be reduced by the Negotiated Power so that it is reserved for the Power Transmitter 102 and not available for other Power Transmitters that share the power source. At 774, the Power Receiver 118 may configure the Guaranteed Power as a maximum limit for subsequent Power Request messages communicated during the power transfer phase.

During the power transfer phase 706, the Power Receiver 118 may transmit a Power Request (P-request) message 780 or other feedback message to request an adjustment to the wireless power transmission. For example, the Power Request message 780 may include a P-request as described with reference to FIG. 6. The P-request may be limited such that it does not exceed the Guaranteed Power that was negotiated with the Power Transmitter 102 based on the Requested Power negotiation value.

At 782, the Power Transmitter 102 may calculate the PTx-loss based on measurements at the inverter of the Power Transmitter 102. At 784, the Power Transmitter 102 may determine a new operating parameter to satisfy the P-request taking into account the calculated PTx-loss.

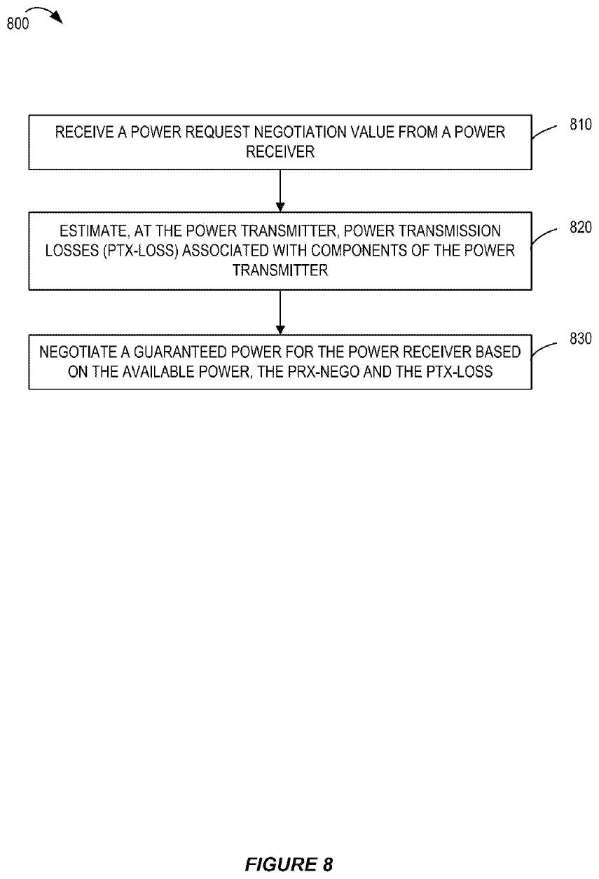

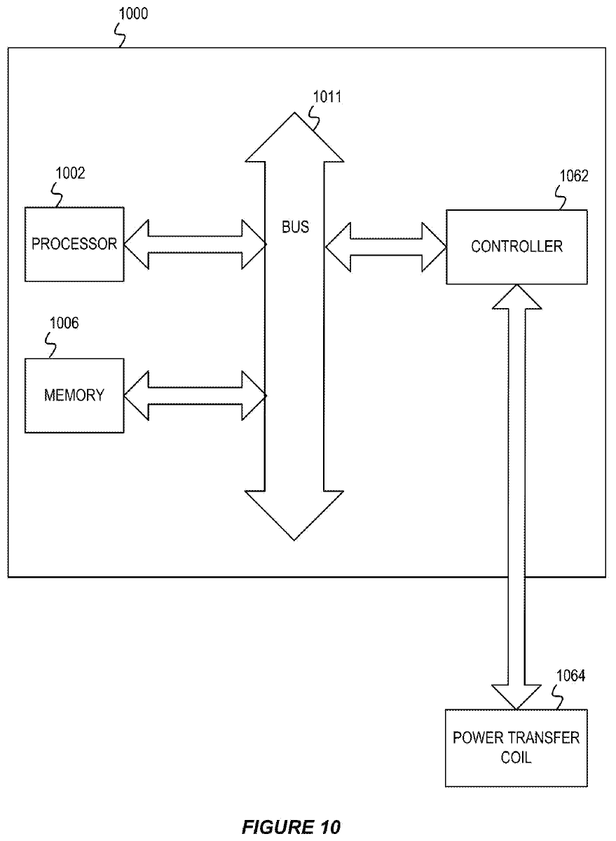

FIG. 8 shows a flow diagram illustrating example operations of a process 800 performed by a Power Transmitter. The operations of the process 800 may be implemented by a Power Transmitter as described herein. For example, the process 800 may be performed by a Power Transmitter 102 or any component thereof (such as a power controller 108) described with reference to FIG. 1, 5, or 6. The process 800 may implement any of the operations described with reference to the system state diagram 300 described with reference to FIG. 3, the power negotiation example described with reference to FIG. 4, or the message flow diagram 700 described with reference to FIG. 67. In some implementations, the process 800 may be performed by an apparatus 1000 such as described with reference to FIG. 10. For brevity, the operations are described as performed by a Power Transmitter.

At block 810, the Power Transmitter may receive a Requested Power negotiation value from a Power Receiver. At block 820, the Power Transmitter may estimate power transmission losses (PTx-loss) associated with components of the Power Transmitter. At block 830, the Power Transmitter may negotiate a Guaranteed Power (P-nego) for the Power Receiver based on the Requested Power negotiation value, the Available Power, and the PTx-loss. The Power Transmitter may reserve a Negotiated Power (sum of the Guaranteed Power and the PTx-loss) out of the Available Power so that the Available Power is reduced for other Power Transmitters that share the Available Power from the power source.

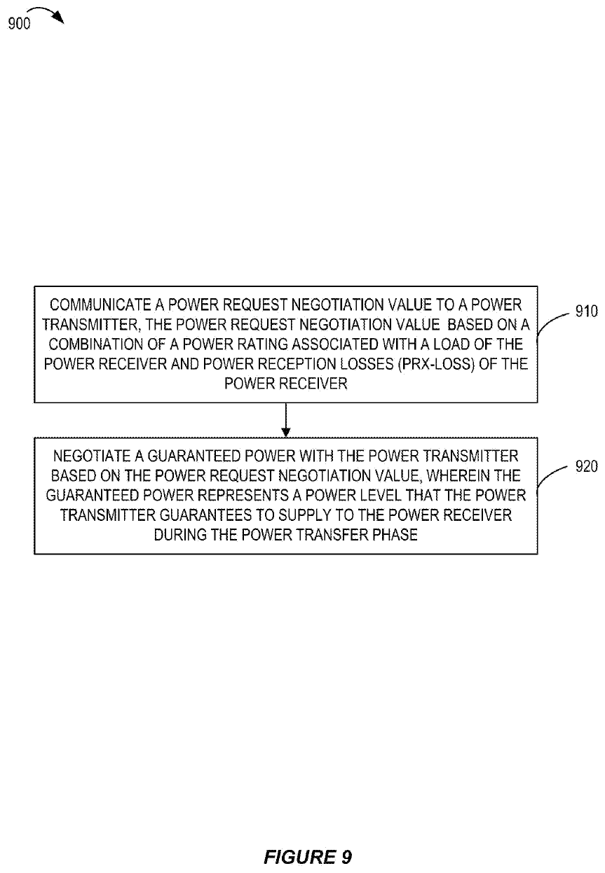

FIG. 9 shows a flow diagram illustrating example operations of a process 900 performed by a Power Receiver. The operations of the process 900 may be implemented by a Power Receiver as described herein. For example, the process 900 may be performed by a Power Receiver 118 or any component thereof (such as an appliance controller 136) described with reference to FIG. 1, 5, or 6. The process 900 may implement any of the operations described with reference to the system state diagram 300 described with reference to FIG. 3 or the message flow diagram 700 described with reference to FIG. 7. In some implementations, the process 900 may be performed by an apparatus 1000 such as described with reference to FIG. 10. For brevity, the operations are described as performed by a Power Receiver.

At block 910, the Power Receiver may communicate a Requested Power negotiation value to a Power Transmitter. The Requested Power negotiation value may be based on a combination of a power rating associated with a load of the Power Receiver and power reception losses (PRx-loss) of the Power Receiver. At block 920, the Power Receiver may negotiate a Guaranteed Power with the Power Transmitter based on the Requested Power negotiation value. The Guaranteed represents power level that the Power Transmitter guarantees to supply Requested Power negotiation value to the Power Receiver. The Power Transmitter may reserve enough power (a sum of the Guaranteed Power and estimated PTx-losses) from its Available Power so that the Power Transmitter can satisfy the Guaranteed Power.

FIG. 10 shows a block diagram of an example apparatus for use in wireless power system. In some implementations, the apparatus 1000 may be a Power Transmitter (such as the Power Transmitter 102) described herein. In some implementations, the apparatus 1000 may be an example of the power controller 108 described with reference to any of the Figures herein. In some implementations, the apparatus 1000 may be a Power Receiver (such as the Power Receiver 118) described herein. In some implementations, the apparatus 1000 may be an example of the appliance controller 136 described with reference to any of the Figures herein.

The apparatus 1000 can include a processor 1002 (possibly including multiple processors, multiple cores, multiple nodes, or implementing multi-threading, etc.). The apparatus 1000 also can include a memory 1006. The memory 1006 may be system memory or any one or more of the possible realizations of computer-readable media described herein. The apparatus 1000 also can include a bus 1011 (such as PCI, ISA, PCI-Express, HyperTransport®, InfiniBand®, NuBus, R AHB, AXI, etc.). The apparatus 1000 may include one or more controller(s) 1062 configured to manage a power transfer coil 1064 (such as a primary or secondary coil. In some implementations, the controller(s) 1062 can be distributed within the processor 1002, the memory 1006, and the bus 1011. The controller(s) 1062 may perform some or all of the operations described herein. For example, the controller(s) 1062 may be a power controller, such as the power controller 108 described with reference to any of FIG. 1, 5, or 6. Alternatively, the controller(s) 1062 may be an appliance controller, such as the appliance controller 136 described with reference to any of FIG. 1, 5, or 6.

The memory 1006 can include computer instructions executable by the processor 1002 to implement the functionality of the implementations described with reference to FIGS. 1-9. Any one of these functionalities may be partially (or entirely) implemented in hardware or on the processor 1002. For example, the functionality may be implemented with an application specific integrated circuit, in logic implemented in the processor 1002, in a co-processor on a peripheral device or card, etc. Further, realizations may include fewer or additional components not illustrated in FIG. 10. The processor 1002, the memory 1006, and the controller(s) 1062 may be coupled to the bus 1011. Although illustrated as being coupled to the bus 1011, the memory 1006 may be coupled to the processor 1002.

The figures, operations, and components described herein are examples meant to aid in understanding example implementations and should not be used to limit the potential implementations or limit the scope of the claims. Some implementations may perform additional operations, fewer operations, operations in parallel or in a different order, and some operations differently.

The foregoing disclosure provides illustration and description but is not intended to be exhaustive or to limit the aspects to the precise form disclosed. Modifications and variations may be made in light of the above disclosure or may be acquired from practice of the aspects. While the aspects of the disclosure have been described in terms of various examples, any combination of aspects from any of the examples is also within the scope of the disclosure. The examples in this disclosure are provided for pedagogical purposes. Alternatively, or in addition to the other examples described herein, examples include any combination of the following implementation options (enumerated as clauses for clarity).

### CLAUSES

Clause 1. A method performed by a Power Transmitter of a wireless power system, including: receiving a Requested Power negotiation value (PRx-nego) from a Power Receiver; estimating, at the Power Transmitter, power transmission losses (PTx-loss) associated with components of the Power Transmitter; and negotiating a Negotiated Power (P-nego) for the Power Receiver based on the PRx-nego, and the PTx-loss.

Clause 2. The method of clause 1, where the P-nego represents an amount of power that the Power Transmitter agrees to reserve for the Power Receiver.

Clause 3. The method any one of clauses 1-2, where the PRx-nego is associated with a load requirement of a load of the Power Receiver.

Clause 4. The method any one of clauses 1-3, where the PRx-nego is based on a combination of a power rating associated with the load and power reception losses (PRx-loss) of the Power Receiver.

Clause 5. The method any one of clauses 1-4, where the PRx-nego from the Power Receiver does not account for the PTx-loss.

Clause 6. The method of any one of clauses 1-5, where, during a connected phase, estimating the PTx-loss includes estimating power transmission losses associated with at least one member of a group consisting of: a copper loss associated with a primary coil of the Power Transmitter, the copper loss calculated using a product of a resistance (R) associated with the primary coil and a square of an estimated rated current (Iinv2) associated with an inverter of the Power Transmitter to meet the PRx-nego; other losses associated with electronics, a capacitor, friendly metals, ferrites, or any combination thereof, associated with the Power Transmitter to meet the PRx-nego.

Clause 7. The method of any one of clauses 1-5, further including, during a power transfer phase: controlling a transmission of wireless power to the Power Receiver using an operating control parameter that is based, at least in part, on a receiver power request P-request.

Clause 8. The method of clause 7, further including, during the power transfer phase: determining a measured power (P-measured) based on an average of an inverter current (Iinv) multiplied by inverter voltage (Vinv) over a time period; determining a measured PTx-loss over the same time period, and adjusting the operating control parameter to control the transmission of wireless power based on the P-measured, the measured PTx-loss, and a power request (P-request) from the Power Receiver indicating a Requested Power that is less than or equal to the PRx-nego.

Clause 9. The method of any one of clauses 7-8, where, during the power transfer phase, determining the measured PTx-loss includes determining power transmission losses associated with at least one member of a group consisting of: a copper loss associated with a primary coil of the Power Transmitter, the copper loss calculated using a product of a resistance (R) associated with the primary coil and a square of a measured current (Iinv2) associated with an inverter of the Power Transmitter; other losses associated with electronics, a capacitor, friendly metals, ferrites, or any combination thereof, associated with the Power Transmitter.

Clause 10. The method of any one of clauses 1-9, where estimating the PTx-loss includes: obtaining the PTx-loss from a memory of the Power Transmitter.

Clause 11. The method of any one of clauses 1-10, where estimating the PTx-loss includes: adjusting the PTx-loss based, at least in part, on a coupling factor (K-factor) indicating an efficiency of a wireless coupling between the Power Transmitter and the Power Receiver.

Clause 12. A method performed by a Power Receiver of a wireless power system, including: communicating a Requested Power negotiation value (PRx-nego) to a Power Transmitter, the PRx-nego based on a combination of a power rating associated with a load of the Power Receiver and power reception losses (PRx-loss) of the Power Receiver; and negotiating a Negotiated Power (P-nego) with the Power Transmitter based on the PRx-nego, where the P-nego represents an amount of power that the Power Transmitter reserves to supply PRx-nego to the Power Receiver. 13. The method of clause 12, where the PRx-nego from the Power Receiver does not account for power transmission losses (PTx-loss) of the Power Transmitter.

Clause 14. The method of any one of clauses 14-13, further including: communicating a power request (P-request) to the Power Transmitter during power transfer phase, the P-request indicating a Requested Power that is less than or equal to the PRx-nego; and receiving a transmission of wireless power from the Power Transmitter based, at least in part, on P-request. 15. A wireless power system, including: one or more Power Transmitters; one or more communication interfaces corresponding to the one or more Power Transmitters, including at least a first communication interface corresponding to a first Power Transmitter, the first communication interface configured to receive a Requested Power negotiation value (PRx-nego) from a Power Receiver; and a controller configured to: determine an Available Power remaining from a power source coupled to the wireless power system based on reserved power amounts for each of the one or more Power Transmitters; estimate a power transmission losses (PTx-loss) associated with components of the first Power Transmitter; and reserve a first reserved power amount for the first Power Transmitter, where the first reserved power amount is based on a combination of the PRx-nego and the PTx-loss and is limited by the Available Power.

Clause 16. The wireless power system of clause 15, further including: the first communication interface configured to communicate an acceptance message to the Power Receiver.

Clause 17. The wireless power system of clause 15, further including: the controller configured to: determine that the first reserved power amount is less than the PRx-nego; and cause the first communication interface to communicate a rejection message to the Power Receiver.

Clause 18. The wireless power system of clause 17, further including: the controller configured to: calculate a second reserved power amount, lower than the first reserved power amount, based on available power and the estimated PTx-loss to meet a different PRx-nego that the Power Transmitter can satisfy; and cause the first communication interface to communicate the different PRx-nego to the Power Receiver as an alternative PRx-nego for negotiation.

Clause 19. A method for power negotiation by a Power Transmitter of a wireless power system, including: receiving a Requested Power negotiation value from a Power Receiver prior to a power transfer phase; determining estimated power transmission losses (PTx-loss) of the Power Transmitter associated with transmitting wireless power to the Power Receiver; negotiating a Guaranteed Power for the Power Receiver based, at least in part, on the Requested Power negotiation value, the estimated PTx-loss, and Available Power of the Power Transmitter; and reserving, from the Available Power, a Negotiated Power (P-nego) for transmission of the wireless power to the Power Receiver during the power transfer phase, where the Negotiated Power is a sum of the Guaranteed Power and the estimated PTx-loss.

Clause 20. The method of clause 19, where negotiating the Guaranteed Power includes: accepting the Requested Power negotiation value as the Guaranteed Power if the Available Power is more than a sum of the Requested Power negotiation value and the estimated PTx-loss; and rejecting the Requested Power negotiation value or communicating an alternative power negotiation value to the Power Receiver if the Available Power is less than the sum of the Requested Power negotiation value and the estimated PTx-loss.

Clause 21. The method of clause 19, where negotiating the Guaranteed Power includes: determining that the Available Power is less than the sum of the Requested Power negotiation value and the estimated PTx-loss; communicating a message to the Power Receiver to reject the Requested Power negotiation value; receiving a subsequent Requested Power negotiation value from the Power Receiver; and accepting the subsequent Requested Power negotiation value as the Guaranteed Power if the Available Power is more than a sum of the subsequent Requested Power negotiation value and the estimated PTx-loss.

Clause 22. The method of clause 19, where negotiating the Guaranteed Power includes: determining that the Available Power is less than the sum of the Requested Power negotiation value and the estimated PTx-loss; calculating an alternative power negotiation value that the Power Transmitter can satisfy, the alternative power negotiation value based on the Available Power minus the estimated PTx-loss; communicating a message to the Power Receiver to indicate the alternative power negotiation value; receiving an acknowledgement from the Power Receiver if the Power Receiver accepts the alternative power negotiation value as the Guaranteed value; and setting the alternative power negotiation value as the Guaranteed Power for the Power Receiver after receiving the acknowledgment.

Clause 23. The method any one of clauses 19-22, where the Requested Power negotiation value is based, at least in part, on a power rating of a load associated with the Power Receiver.

Clause 24. The method of clause 23, where the Requested Power negotiation value is based on a combination of a power rating of the load and estimated Power Receiver losses (PRx-loss).

Clause 25. The method of any one of clauses 19-24, where the estimated PTx-loss includes power transmission losses associated with at least one member of a group consisting of: a copper loss associated with a primary coil of the Power Transmitter, the copper loss calculated using a product of a resistance (R) associated with the primary coil and a square of an estimated rated current (Iinv2) associated with an inverter of the Power Transmitter to meet the Requested Power negotiation value; and other losses associated with any combination of a rectifier, an inverter, a coil, a filter component, a capacitor, or friendly metals of the Power Transmitter associated with the Power Transmitter to meet the Requested Power negotiation value.

Clause 26. The method of any one of clauses 19-25, where determining the estimated PTx-loss includes obtaining the estimated PTx-loss from a memory of the Power Transmitter.

Clause 27. The method of any one of clauses 19-26, where determining the estimated PTx-loss includes adjusting the estimated PTx-loss based, at least in part, on a coupling factor (K-factor) indicating an efficiency of a wireless coupling between the Power Transmitter and the Power Receiver.

Clause 28. The method of any one of clauses 19-27, further including, during the power transfer phase: controlling transmission of the wireless power to the Power Receiver using an operating control parameter that is based, at least in part, on a Power Request (P-request) message received from the Power Receiver.

Clause 29. The method of clause 28, where the P-request message indicates a requested power that is less than or equal to the Guaranteed Power.

Clause 30. The method of any one of clauses 28-29, further including, during the power transfer phase: determining a measured power (P-measured) based on an average of an inverter current (Iinv) multiplied by inverter voltage (Vinv) over a time period; determining a measured PTx-loss over the same time period; receiving a Power Request (P-request) message from the Power Receiver; and adjusting the operating control parameter to control the transmission of wireless power based on the P-measured, the measured PTx-loss, and the P-request message.

Clause 31. The method of any one of clauses 19-30, where: the Power Transmitter is part of a Magnetic Power Source configured to share the Available Power among multiple Power Transmitters, each of the multiple Power Transmitters are configured to reserve respective Negotiated Power amounts for respective Power Receivers, and the Available Power represents power from the Magnetic Power Source remaining available after the respective Negotiated Power amounts have been reserved.

Clause 32. A method for power negotiation by a Power Receiver of a wireless power system, including: communicating a Requested Power negotiation value to a Power Transmitter prior to a power transfer phase, the Requested Power negotiation value based, at least in part, on a power rating of a load associated with the Power Receiver; and negotiating a Guaranteed Power with the Power Transmitter based on the Requested Power negotiation value, where the Guaranteed Power represents a power level that the Power Transmitter guarantees to have available for transmission to the Power Receiver during the power transfer phase based on Available Power of the Power Transmitter and estimated power transmission losses (PTx-loss) of the Power Transmitter.

Clause 33. The method of clause 32, where negotiating the Guaranteed Power includes determining that the Power Transmitter has reserved, from the Available Power of the Power Transmitter, a sum of the Guaranteed Power and the PTx-Loss.

Clause 34. The method of any one of clauses 32-33, where the Requested Power negotiation value is based on a combination of the power rating of the load and estimated Power Receiver losses (PRx-loss) of the Power Receiver.

Clause 35. The method of any one of clauses 32-34, where negotiating the Guaranteed Power includes: receiving a message from the Power Transmitter rejecting the Requested Power negotiation value if the Available Power is less than the sum of the Requested Power negotiation value and the estimated PTx-loss.

Clause 36. The method of clause 35, where negotiating the Guaranteed Power further includes: communicating a subsequent Requested Power negotiation value to the Power Transmitter; and determining whether the Power Transmitter accepts the subsequent Requested Power negotiation value as the Guaranteed Power, where the subsequent Requested Power negotiation value is accepted if the Available Power is more than a sum of the subsequent Requested Power negotiation value and the estimated PTx-loss.

Clause 37. The method of any one of clauses 32-36, where negotiating the Guaranteed Power includes: receiving a message from the Power Transmitter indicating an alternative power negotiation value, where the alternative power negotiation value is based on the Available Power minus the estimated PTx-loss; and communicating an acknowledgement to the Power Transmitter to indicate acceptance of the alternative power negotiation value as the Guaranteed value.

Clause 38. The method of any one of clauses 32-37, further including: communicating a Power Request (P-request) message to the Power Transmitter during the power transfer phase, the P-request message indicating a Requested Power that is less than or equal to the Guaranteed Power; and receiving a transmission of wireless power from the Power Transmitter based, at least in part, on P-request message.

Clause 39. A Power Transmitter configured to perform any one of the methods of clauses 1-11 and 19-31.

Clause 40. A Power Receiver configured to perform any one of the methods of clauses 12-14 and 32-37.

Another innovative aspect of the subject matter described in this disclosure can be implemented as an apparatus. The apparatus may include a modem and at least one processor communicatively coupled with the at least one modem. The processor, in conjunction with the modem, may be configured to perform any one of the above-mentioned methods or features described herein.

Another innovative aspect of the subject matter described in this disclosure can be implemented as a computer-readable medium having stored therein instructions which, when executed by a processor, causes the processor to perform any one of the above-mentioned methods or features described herein.

Another innovative aspect of the subject matter described in this disclosure can be implemented as a system having means for implementing any one of the above-mentioned methods or features described herein.

As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus used to implement the various illustrative components, logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, or, any conventional processor, controller, microcontroller, or state machine. A processor also may be implemented as a combination of computing devices, for example, a combination of a DSP and a microprocessor, multiple microprocessors, one or more microprocessors in conjunction with a DSP core, or any other such configuration. In some implementations, particular processes, operations and methods may be performed by circuitry that is specific to a given function.

As described above, in some aspects of the subject matter described in this specification can be implemented as software. For example, various functions of components disclosed herein, or various blocks or steps of a method, operation, process or algorithm disclosed herein can be implemented as one or more modules of one or more computer programs. Such computer programs can include non-transitory processor-executable or computer-executable instructions encoded on one or more tangible processor-readable or computer-readable storage media for execution by, or to control the operation of, a data processing apparatus including the components of the devices described herein. By way of example, and not limitation, such storage media may include RAM, ROM, EEPROM, CD-ROM or other optical disk storage, magnetic disk storage or other magnetic storage devices, or any other medium that may be used to store program code in the form of instructions or data structures. Combinations of the above should also be included within the scope of storage media.

Various modifications to the implementations described in this disclosure may be readily apparent to persons having ordinary skill in the art, and the generic principles defined herein may be applied to other implementations without departing from the scope of this disclosure. Thus, the claims are not intended to be limited to the implementations shown herein but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

1. A method for power negotiation by a Power Transmitter of a wireless power system, comprising:
receiving a Requested Power negotiation value from a Power Receiver prior to a power transfer phase;
determining estimated power transmission losses (PTx-loss) of the Power Transmitter associated with transmitting wireless power to the Power Receiver;
negotiating a Guaranteed Power for the Power Receiver based, at least in part, on the Requested Power negotiation value, the estimated PTx-loss, and Available Power of the Power Transmitter; and
reserving, from the Available Power, a Negotiated Power (P-nego) for transmission of the wireless power to the Power Receiver during the power transfer phase, wherein the Negotiated Power is a sum of the Guaranteed Power and the estimated PTx-loss.

2. The method of claim 1, wherein negotiating the Guaranteed Power includes:
accepting the Requested Power negotiation value as the Guaranteed Power if the Available Power is more than a sum of the Requested Power negotiation value and the estimated PTx-loss; and
rejecting the Requested Power negotiation value or communicating an alternative power negotiation value to the Power Receiver if the Available Power is less than the sum of the Requested Power negotiation value and the estimated PTx-loss.

3. The method of claim 1, wherein negotiating the Guaranteed Power includes:
determining that the Available Power is less than a sum of the Requested Power negotiation value and the estimated PTx-loss;
communicating a message to the Power Receiver to reject the Requested Power negotiation value;
receiving a subsequent Requested Power negotiation value from the Power Receiver; and
accepting the subsequent Requested Power negotiation value as the Guaranteed Power if the Available Power is more than a sum of the subsequent Requested Power negotiation value and the estimated PTx-loss.

4. The method of claim 1, wherein negotiating the Guaranteed Power includes:
determining that the Available Power is less than a sum of the Requested Power negotiation value and the estimated PTx-loss;
calculating an alternative power negotiation value that the Power Transmitter can satisfy, the alternative power negotiation value based on the Available Power minus the estimated PTx-loss;
communicating a message to the Power Receiver to indicate the alternative power negotiation value;
receiving an acknowledgement from the Power Receiver if the Power Receiver accepts the alternative power negotiation value as the Guaranteed value; and
setting the alternative power negotiation value as the Guaranteed Power for the Power Receiver after receiving the acknowledgment.

5. The method of claim 1, wherein the Requested Power negotiation value is based, at least in part, on a power rating of a load associated with the Power Receiver.

6. The method of claim 5, wherein the Requested Power negotiation value is based on a combination of a power rating of the load and estimated Power Receiver losses (PRx-loss).

7. The method of claim 1, wherein the estimated PTx-loss includes power transmission losses associated with at least one member of a group consisting of:
a copper loss associated with a primary coil of the Power Transmitter, the copper loss calculated using a product of a resistance (R) associated with the primary coil and a square of an estimated rated current (Iᵢₙᵥ²) associated with an inverter of the Power Transmitter to meet the Requested Power negotiation value; and
other losses associated with any combination of a rectifier, an inverter, a coil, a filter component, a capacitor, or friendly metals of the Power Transmitter associated with the Power Transmitter to meet the Requested Power negotiation value.

8. The method of claim 1, wherein determining the estimated PTx-loss includes obtaining the estimated PTx-loss from a memory of the Power Transmitter.

9. The method of claim 1, wherein determining the estimated PTx-loss includes adjusting the estimated PTx-loss based, at least in part, on a coupling factor (K-factor) indicating an efficiency of a wireless coupling between the Power Transmitter and the Power Receiver.

10. The method of claim 1, further comprising, during the power transfer phase:
controlling transmission of the wireless power to the Power Receiver using an operating control parameter that is based, at least in part, on a Power Request (P-request) message received from the Power Receiver.

11. The method of claim 10, wherein the P-request message indicates a requested power that is less than or equal to the Guaranteed Power.

12. The method of claim 10, further comprising, during the power transfer phase:
determining a measured power (P-measured) based on an average of an inverter current (Iᵢₙᵥ) multiplied by inverter voltage (Vᵢₙᵥ) over a time period;
determining a measured PTx-loss over the same time period;
receiving a Power Request (P-request) message from the Power Receiver; and
adjusting the operating control parameter to control the transmission of wireless power based on the P-measured, the measured PTx-loss, and the P-request message.

13. The method of claim 1, wherein:
the Power Transmitter is part of a Magnetic Power Source configured to share the Available Power among multiple Power Transmitters,
each of the multiple Power Transmitters are configured to reserve respective Negotiated Power amounts for respective Power Receivers, and
the Available Power represents power from the Magnetic Power Source remaining available after the respective Negotiated Power amounts have been reserved.

14. A method for power negotiation by a Power Receiver of a wireless power system, comprising:
communicating a Requested Power negotiation value to a Power Transmitter prior to a power transfer phase, the Requested Power negotiation value based, at least in part, on a power rating of a load associated with the Power Receiver; and
negotiating a Guaranteed Power with the Power Transmitter based on the Requested Power negotiation value, wherein the Guaranteed Power represents a power level that the Power Transmitter guarantees to have available for transmission to the Power Receiver during the power transfer phase based on Available Power of the Power Transmitter and estimated power transmission losses (PTx-loss) of the Power Transmitter.

15. The method of claim 14, wherein negotiating the Guaranteed Power includes determining that the Power Transmitter has reserved, from the Available Power of the Power Transmitter, a sum of the Guaranteed Power and the PTx-Loss.

16. The method of claim 14, wherein the Requested Power negotiation value is based on a combination of the power rating of the load and estimated Power Receiver losses (PRx-loss) of the Power Receiver.

17. The method of claim 14, wherein negotiating the Guaranteed Power includes:
receiving a message from the Power Transmitter rejecting the Requested Power negotiation value if the Available Power is less than a sum of the Requested Power negotiation value and the estimated PTx-loss.

18. The method of claim 17, wherein negotiating the Guaranteed Power further includes:
communicating a subsequent Requested Power negotiation value to the Power Transmitter; and
determining whether the Power Transmitter accepts the subsequent Requested Power negotiation value as the Guaranteed Power, wherein the subsequent Requested Power negotiation value is accepted if the Available Power is more than a sum of the subsequent Requested Power negotiation value and the estimated PTx-loss.

19. The method of claim 14, wherein negotiating the Guaranteed Power includes:
receiving a message from the Power Transmitter indicating an alternative power negotiation value, wherein the alternative power negotiation value is based on the Available Power minus the estimated PTx-loss; and
communicating an acknowledgement to the Power Transmitter to indicate acceptance of the alternative power negotiation value as the Guaranteed value.

20. The method of claim 14, further comprising:
communicating a Power Request (P-request) message to the Power Transmitter during the power transfer phase, the P-request message indicating a Requested Power that is less than or equal to the Guaranteed Power; and
receiving a transmission of wireless power from the Power Transmitter based, at least in part, on P-request message.

21. A Power Transmitter of a wireless power system, comprising:
a primary coil configured to transmit wireless power to a secondary coil of a Power Receiver during a power transfer phase;
a communication unit configured to receive a Requested Power negotiation value from a Power Receiver prior to the power transfer phase; and
a power controller configured to:
determine estimated power transmission losses (PTx-loss) of the Power Transmitter associated with transmitting the wireless power to the Power Receiver,
negotiate a Guaranteed Power for the Power Receiver based, at least in part, on the Requested Power negotiation value, the estimated PTx-loss, and Available Power of the Power Transmitter, and
reserve, from the Available Power, a Negotiated Power (P-nego) for transmission of the wireless power to the Power Receiver during the power transfer phase, wherein the Negotiated Power is a sum of the Guaranteed Power and the estimated PTx-loss.

22. The Power Transmitter of claim 21, wherein the power controller is configured to:
accept the Requested Power negotiation value as the Guaranteed Power if the Available Power is more than a sum of the Requested Power negotiation value and the estimated PTx-loss; and
reject the Requested Power negotiation value or communicating an alternative power negotiation value to the Power Receiver if the Available Power is less than the sum of the Requested Power negotiation value and the estimated PTx-loss.

23. The Power Transmitter of claim 21, wherein:
the power controller is configured to cause the communication unit to communicate a message to the Power Receiver to reject the Requested Power negotiation value when the Available Power is less than the sum of the Requested Power negotiation value and the estimated PTx-loss,
the communication unit is configured to receive a subsequent Requested Power negotiation value from the Power Receiver, and
the power controller is configured to accept the subsequent Requested Power negotiation value as the Guaranteed Power if the Available Power is more than a sum of the subsequent Requested Power negotiation value and the estimated PTx-loss.

24. The Power Transmitter of claim 21, wherein
the power controller is configured to:
determine that the Available Power is less than the sum of the Requested Power negotiation value and the estimated PTx-loss;
calculate an alternative power negotiation value that the Power Transmitter can satisfy, the alternative power negotiation value based on the Available Power minus the estimated PTx-loss;
cause the communication unit to communicate a message to the Power Receiver to indicate the alternative power negotiation value;
the communication unit is configured to receive an acknowledgement from the Power Receiver if the Power Receiver accepts the alternative power negotiation value as the Guaranteed value; and
the power controller is configured to set the alternative power negotiation value as the Guaranteed Power for the Power Receiver after receiving the acknowledgment.

25. The Power Transmitter of claim 21, wherein the Requested Power negotiation value is based, at least in part, on a power rating of a load associated with the Power Receiver.

26. The Power Transmitter of claim 25, wherein the Requested Power negotiation value is based on a combination of a power rating of the load and estimated Power Receiver losses (PRx-loss).

27. The Power Transmitter of claim 21, further comprising:
a memory for storing the estimated PTx-loss,
wherein the power controller is configured to obtain the estimated PTx-loss from the memory.

28. The Power Transmitter of claim 21, wherein the power controller is further configured to:
determine a coupling factor (K-factor) indicating an efficiency of a wireless coupling between the Power Transmitter and the Power Receiver; and
adjust the estimated PTx-loss based, at least in part, on the coupling factor.

29. The Power Transmitter of claim 21, wherein the power controller is further configured to:
during the power transfer phase, control transmission of the wireless power to the Power Receiver using an operating control parameter that is based, at least in part, on a Power Request (P-request) message received from the Power Receiver.

30-31. (canceled)
